(19) United States
(12) Patent Application Publication
(10) Pub. No.: US 2021/0034616 A1
(43) Pub. Date: Feb. 4, 2021

(54) QUERY OPTIMIZATION

(71) Applicant: Instant Labs, Inc., Santa Clara, CA (US)

(72) Inventors: Eric Kiebler, Half Moon Bay, CA (US); John McLaughlin, Roseland, NJ (US); Hal Spitz, Oakland, CA (US); Rene Stein, Palo Alto, CA (US); Brigand Balleau, Albany, CA (US); Ajit Shantilal Shah, Portola Valley, CA (US)

(21) Appl. No.: 16/941,101

(22) Filed: Jul. 28, 2020

Related U.S. Application Data
(60) Provisional application No. 62/881,898, filed on Aug. 1, 2019.

(51) Int. Cl. G06F 16/2453

(52) U.S. Cl. CPC G06F 16/2453; G06F 16/24539

(57) ABSTRACT

A technique for query optimization includes determining that a query is associated with the query object, obtaining persistently-stored query response information associated with the query object, and using the persistently-stored query response information to generate a response to the query. The query optimization can be continuously performed.

### CROSS REFERENCE TO OTHER APPLICATIONS

This application claims priority to U.S. Provisional Patent Application No. 62/881,898 entitled CONTINUOUS QUERY OPTIMIZATION filed Aug. 1, 2019 which is incorporated herein by reference for all purposes.

### BACKGROUND OF THE INVENTION

Modern database systems are able to handle large volumes of data and provide powerful tools to access and manipulate data. However, the power of modern database systems and the wide range of functionality provided can result in excessive latency and high resource consumption. Some tasks require the full capability of a modern Relational Database Management System (RDBMS), while performing other tasks is more straightforward but still requires substantial time and resources using an RDBMS or other traditional, full-function enterprise class database.

### BRIEF DESCRIPTION OF THE DRAWINGS

Various embodiments of the invention are disclosed in the following detailed description and the accompanying drawings.

FIG. 1 is a flow diagram illustrating an embodiment of a process for query handling using a query object.

FIG. 2 illustrates an example of query processing using a query object according to an embodiment of the present disclosure.

FIG. 3 is a flow diagram illustrating an embodiment of a process for continuous query optimization.

FIG. 4 is a block diagram illustrating an embodiment of a system for continuous query optimization.

FIG. 5 is a flow diagram illustrating an embodiment of a process for continuous query optimization corresponding to the system shown in FIG. 4.

FIG. 6 is block diagram illustrating an embodiment of a system for optimized data access.

FIG. 7 is a flow diagram illustrating an embodiment of a process for determining that a query is associated with a query object.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A query is typically processed by a database query processor that plans how to execute the query. Planners convert declarative database statements (e.g., SQL language) into imperatives that can be executed on hardware to retrieve the desired data. Planners typically work on each query as it is received by a database. Planners create a query execution plan (sometimes simply called a query plan), which is a strategy or sequence of steps to access the requested data in a database. There may be several different possible plans to execute a query. The time taken to parse the query and make a query plan can be a major portion of the query processing time.

To reduce query processing times, planners typically are given a time budget, also known as a time-box. Should the planning effort not complete within this budget, the planner responds with the best plan it discovered within the time-box. A conventional technique for reducing query processing time is by using an existing plan if a query is identical to a previously-received query. However, subsequent queries are not always identical to previously-received queries and therefore conventional techniques do not use existing plans even when they are similar enough to benefit from using existing plans.

Techniques are disclosed to optimize query execution. In various embodiments, information associated with a query is stored persistently, e.g., as a first class object, sometimes referred to herein as a “query object”. The query object or other representation may be stored persistently such as across database statement (e.g., SQL statement) invocations or executions. The query object or other representation may include and/or be associated with persistently stored information that is or may be used to process a subsequently received query determined to be associated with the query object. In some embodiments, the query object may include or be associated with an optimized plan to process a query associated with the query object. Offline, for example subsequent to responding to an instance of the query, e.g., by returning a query result determined according to a query plan determined to respond the instance of the query, the query object or other representation may be used to perform further optimization processing to determine a further optimized plan to be available to be used to process a future instance associated with the query. In some embodiments, query response information other than an optimized query plan may be stored persistently and included in or otherwise associated with a query object as disclosed herein. In various embodiments, the future instance of the query need not be identical to an earlier query to benefit from using an associated optimized plan. Instead, subsequent queries determined to be similar (or equivalent) to earlier queries use the optimized plans associated with the earlier queries.

Performing continuous optimization as disclosed herein is different from traditional query caching. In the latter approach, a query and the returned results are cached. If a query identical to the cached query is received while the results remain in the cache, the cached results are returned. By contrast, in the approach disclosed herein, the query and query response information (such as an optimized plan associated with the query) are persistently stored (e.g., in cache). Examples of query response information includes information instead of or in addition to query results such as the parsed form of a query, query plan, indexes used, optimization details, etc. The query response information is updated as the continuous optimization processing determines a more highly (better) optimized plan for the query. A response to a subsequent query that is associated with the query for which query response information exists is formed by using the cached query response information to generate results for the query. The response does not (necessarily) return previously stored results but may instead be formed from results using the stored results based on a recognition of similarity between queries.

Another conventional technique to reduce query processing time is to use a VIEW (e.g., “[Prices Over 50]”), which is a composition of table(s) that can be queried for example by calling “SELECT*FROM [Prices Over 50] WHERE color=‘red’. The SELECT statement is executed by running a first query corresponding to the VIEW [Prices Over 50], and then running a second query on the table/result set of the first query to obtain a final result set. This can be slow because constraints are applied after getting the table/data instead of before getting the data.

The disclosed techniques are more versatile than conventional techniques because additional information such as indices (used), result sets, and other information associated with the query is retained. By contrast, a VIEW is simply a SQL statement that is stored with an associated name and does not retain such information. Typically, a composition is performed at the time a query is received, and, when finished, the composition is discarded. That is, information such as the semantics (e.g., indices and associated WHERE clauses) are not persistently stored in conventional systems. The disclosed query object reduces processing time because, unlike a VIEW, indices and past results do not need to be re-generated.

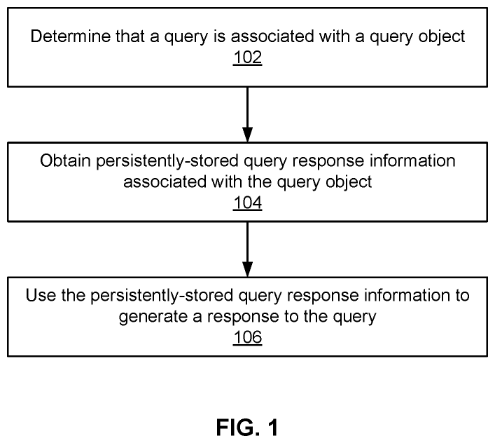

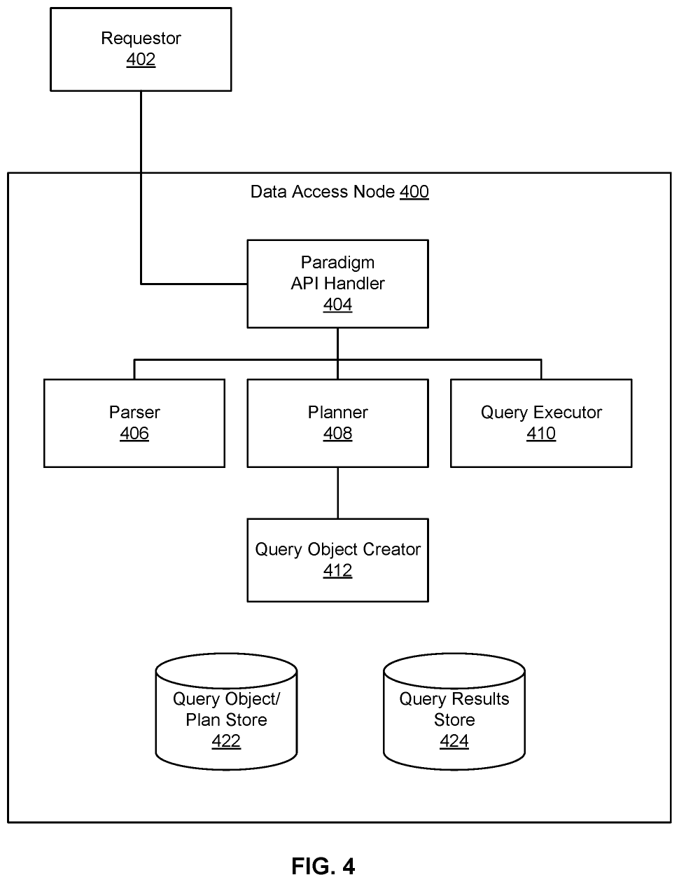

FIG. 1 is a flow diagram illustrating an embodiment of a process for query handling using a query object. This process may be implemented on or by a processor such as data access node of FIG. 4.

The process begins by determining that a query is associated with a query object (102). A query accesses (retrieves) and manipulates data from a database based on specific criteria. As used herein, a query object is a first-class object, data structure, or other entity that is individually identifiable and represents a specific query. The query object can be dynamically created, destroyed, passed to a function, and/or returned as a value. A query object is created for a query so that the query be uniquely identified and later referenced. As such, treating queries as first-class objects gives them an identity independent of their value. In various embodiments, this approach allows potentially different expressions of the query to retain an identity beyond a single query execution. Thus the query of 102 can be determined to be associated with a query object identifying a previously-received query.

In various embodiments, a subsequent instance of a query is determined to be the equivalent to a previously-optimized query for purposes of using a continuously optimized query plan generated based on a previously-received query, as disclosed herein, at least in part based on query content as further discussed below. A query may be determined to be equivalent if the query explicitly references an earlier query or based on similarity as further described below.

In some embodiments, a query may be identified explicitly as a query for which a previously-optimized (and/or continuously further optimized) query plan exists. For example, the later-received query may include or identify the query by a query object identifier, e.g., a globally unique number or other identifier.

In some embodiments, a query for which a (continuously) optimized plan exists may be identified by and/or associated with a string, hash, or other value or set of values that identify an operative semantic part of the query. If the operative semantic part (e.g., “fragment” or JOIN) is equivalent, for query planning purposes, the continuously-optimized plan is used in some embodiments to respond to the query, as disclosed herein.

The process obtains persistently-stored query response information associated with the query object (104). One example of persistently-stored query response information is a query plan, which may be optimized using the disclosed techniques. Another example is a database query. The query response information is persistently stored meaning that the information is stored beyond the lifetime of a query unlike conventional query handling techniques. The query response information can be generated in response to a previously-received query and stored for use by future queries among other things.

The process uses the persistently-stored query response information to generate a response to the query (106). For example, if the query response information is a query plan, the query plan is executed to obtain results that are used to respond to the query. In various embodiments, the response to query can be generated without needing to recompile the query because the query has been previously parsed, planned, and computed.

Sometimes more than one query object may be associated with a query because several query objects may each be helpful in running the query. The process may select the query object that best meets a performance objective such as the query object that runs the fastest, the query object that uses the least computational resources, the query object the gives the most results, etc. Alternatively, the process may combine persistently-stored query response information of multiple query objects to generate a response to the query. Query objects (from previous queries) can be thought of as a partial execution of the current query so that one or more of the query objects are used to generate a results set for the current query.

The process of FIG. 1 will now be explained using the following figure, which shows an example of how to handle a query using this process.

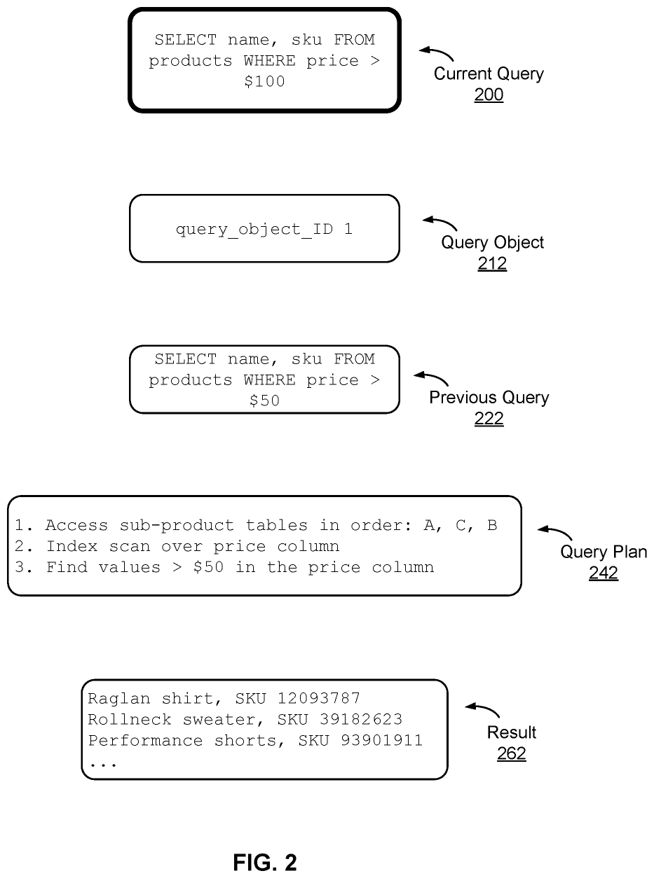

FIG. 2 illustrates an example of query processing using a query object according to an embodiment of the present disclosure. The process of FIG. 1 determines a current query 200 is associated with previous results, namely query object 212, because the current query (200) for products over $100 is similar to a previous query (222) for products over $50. Persistently-stored query response information associated with query object 212 is obtained and used to generate a response to query 200. Here the persistently-stored query response information as identified by query object 212 is query plan 242. Executing query plan 242 obtains results 262, which are the names and SKUs of products costing $50 or more. Results 242 may be further refined to obtain those products costing $100 or more (which is a subset of results 262). Using query plan 242 reduces processing time because the results are already available and work that has been previously done to obtain the results does not need be repeated for the current query. Example of work that was previously done may include considering various possible plans, using a cost function to determine a best one, then generating and executing low level instructions to gather results.

The examples described here use SQL statements, but the techniques for continuous query optimization can be extended to other types of queries. A SQL statement may include elements such as keywords, identifiers, and predicates. A SQL statement typically begins with a verb keyword describing an action to perform. For example, the verb keyword SELECT returns a result set of records. An identifier identifies database objects such as tables or columns/fields within a table. For example, the identifier “products” refers to a table of products. A predicate specifies conditions that can be evaluated. For example, price >$100 evaluates to true for items over $100, and a SELECT statement with this predicate would retrieve those items over $100. A (complex) predicate can include several conditions or clauses. The query “SELECT name, sku FROM products WHERE price >$100” returns the names and SKUs of items costing more than $100 from data source “products.” This query and its results can be stored in a query object, in this example an object identified by “query_object_ID 1.”

One way an association between a query and a query object is identified is by parsing the query to discover that the query is explicitly identifying a query object. In some embodiments, a query may explicitly refer to a query object by identifying one or more specific query objects to be used to generate a response to the query. For example “SELECT*FROM query_object_ID 1 WHERE price >$200” operates on the results associated with query_object_ID 1 to return those items costing more than $200. Using the query object is faster than performing the statement from scratch because there is less data to search through.

In some embodiments, an association between a query and a query object is identified is by determining that the query is identical to a previously-received query or different from the previously-received query but similar in a way that indicates that persistently stored query response information (e.g., a query plan) associated with the previously-received query may be useful to respond to the query. Queries may be identified to be similar to each other if they are similar semantically, equivalent, close, or otherwise would benefit from using a results set already generated for an earlier planned/executed query.

In some embodiments, a query is semantically compared to a query object by determining that at least one portion (e.g., predicate) of a query is at least one of: the same as, equivalent to (syntactically different but semantically the same), or subsumed within corresponding information associated with the query object. For example, a query is parsed to extract its constituent elements, at least a semantically significant subset of which are compared with the elements of previously-received queries. In some embodiments, a query is parsed to determine its predicates and the predicates are looked up in a lookup table to determine whether they match (at least in part) with a previously-received query. This approach in various embodiments enables a subsequent query that is (essentially) the same as a previous query for which a highly-optimized plan is retained to be executed using the retained plan, even if one or more arguments of the later-received query are different than the previously-processed query. Also, results can be returned quickly using the retained plan even if the data has changed, since the retained plan is executed at run time to generate results to respond to the later-received query.

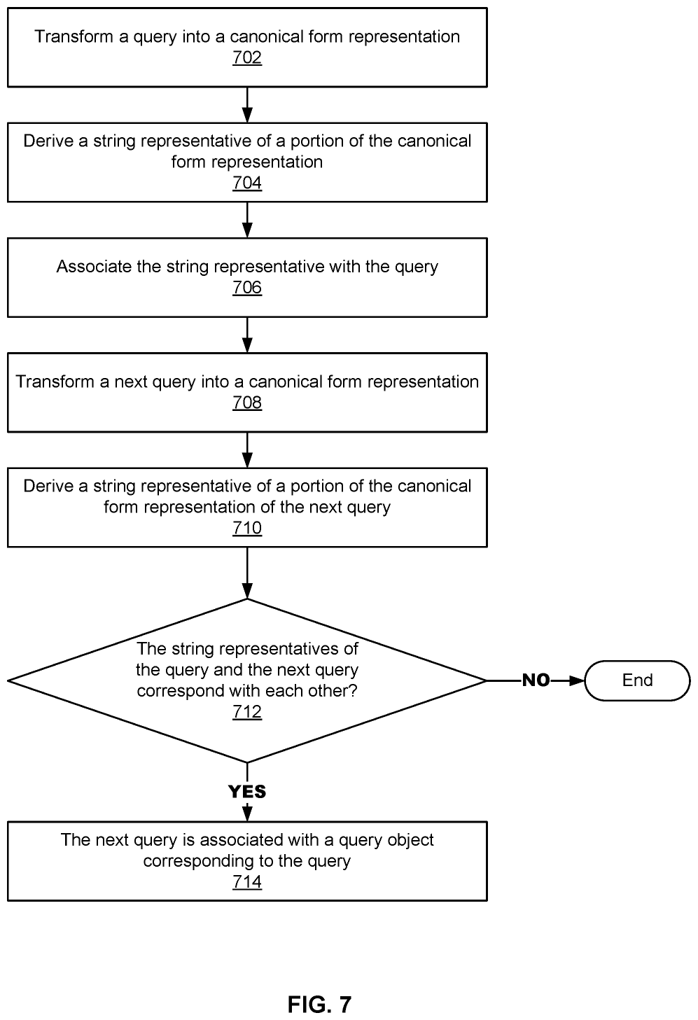

In some embodiments, to determine equivalence, a query may be parsed and/or otherwise transformed into a canonical form, such as an abstract syntax tree or other hierarchical representation as further discussed below with respect to FIG. 7. A string representative of a semantically relevant portion of the representation may be derived and stored and/or otherwise associated with the query and/or the (continuously) optimized plan for the query. A subsequently-received query may be processed at least in part by similarly parsing/transforming the query to derive the corresponding string or other part, and the derived information used to determine if an optimized plan for the query is stored. If so, the optimized plan is used to perform the query. In various embodiments, one or more arguments (parameters) comprising the query may be used to populate the optimized plan for execution to respond to the query. Previously generated/executed low level instructions can be re-used because low level instructions. By contrast, conventionally an entire query is hashed rather than its subparts.

To give a more specific example, query 222 is parsed to find a primitive constraint price >$50. The results of this constraint (predicate) is stored. A subsequently-received query 200 includes a constraint for price >$50. The results of the subpart of the earlier query (price >$100) can be used for the subsequently-received query because it is recognized that the two predicates are similar. Referring to the first primitive constraint (price >$100), where the scalar value is $100, any other predicate with a scalar value smaller than $100 can be considered similar because it can used to build the results set for a query for price >$100.

To give another example where results of query is not a simple subset of results of a previously-received query, suppose the constraints of a previously-received query are color=red and type=shirt. A current query for color=red and type=shoes can use the query plan from the previously-received query. The two queries may be determined to be similar based on metadata such as type association with tables. For example, it is recognized that shirt and shoe data come from the same tables, so the same plan can be used for either type of query. In some embodiments, instead of using the same plan, the plan can be shifted based on statistics of the table such as the way or amount of data stored for shirts vs. shoes. The previously-received query can be used by replacing one or more arguments (parameters) of the previous query to populate the optimized plan for execution to respond to the current query. More specifically, “shirt” can be replaced with “shoes” from the earlier query plan.

In some embodiments, it may be determined that is not efficient to use a previous query. For example, the previous query for color=red and type=shirt should not be used for a current query for color=red and type=shoes because the density of data is different, e.g., there are very few results for red shirts and many results for red shoes. As another example, different index types are used for shoes vs. shirts so that using the plan associated with the previously-received query is not appropriate. Suppose a shirt-specific index type is a radix tree, while a shoe-specific index type is a B-tree. This may indicate that using the shirt query plan does not work well for the current shoe query.

In some embodiments, a sub-optimal plan is used and further optimization is performed offline so that it can used for future queries. For example, using a query plan for a previous query for color=red and type=shirt is only slightly more efficient than not using the query but the query plan is used nonetheless for color=red and type-shoes, and further optimization is performed offline.

In various embodiments, recognizing query similarity is based on an indexing strategy that uses multiple indexes for each query. If a particular index was used for a particular predicate, the next time the predicate is seen in a query, the same index can be used. Predicates can be processed horizontally or vertically. For example, a horizontal processor processes predicates of several queries (e.g., horizontal processing) while a vertical processor executes an entire predicate and generates a temporary results set that can be used. Horizontal and vertical processing may be performed separately or concurrently. By contrast, conventionally only one index is used per table so a conventional query plan is based on one index per table.

Suppose at first queries come in a distribution pattern where most queries are for price >$50. Later on, queries are more evenly distributed between the following constraints: price >$100, price >$200, and price >$300. It turns out that the new distribution is due to searches for slots: >$50 and <$100, >$100 and <$200, etc. A new index can be created to represent a slot instead of using the indexes for the earlier distribution of queries, which are now not as efficient.

Query similarity can be determined by looking for similarities in time based on a predicate, across time using multiple predicates, or checking multiple queries that are not obviously similar. For example, parts of a WHERE clause is checked to see if any portion matches one or more WHERE clause parts of an earlier query (object). As another example, a projection list is checked to see if results are properly formatted for use to respond to the current query. Suppose a first query selects the ID, Name, and Telephone Number columns of a table and a later query is to select all columns. Conventionally, the later query would need to be executed to select all columns. The disclosed techniques use the results of the first query (because it is deemed to be similar to the later query) because it reduces the work performed to generate the full results set for the later query.

For simplicity, this example shows a single query object 212 and its associated query 222, query plan 242, and result 262. In other examples, there may exist multiple query objects, query plans, and results from which one or more are selected to be used to respond to a current query. More than one query object can be used to generate a query response.

Suppose a current query is “SELECT name, sku FROM products WHERE price <$100 and type=shirt.” Suppose two previous queries are: “SELECT name, sku FROM products WHERE price <$50” and “SELECT name, sku FROM products WHERE type=shirt.” The query objects corresponding to the two previous queries can be combined to generate results for the current query. The two objects can be composed using a horizontal processor and/or vertical processor. In this example, a vertical processor composes the query clauses from the two previous queries find those shirts costing less than $50. The current query would simply need to find any additional shirts that cost between $50.01 and $99. In various embodiments, a vertical processor is more efficient for ANDing while a horizontal processor is more efficient for ORing.

Query plan 242 may have been generated when previous query 222 was compiled and/or executed and/or may be derived from a query plan generated to respond to previous query 222 but subsequently (further) optimized. For simplicity, a single query plan is shown here. This may be the optimal query plan selected for query 222 from among several query plan options. In various embodiments, query plan 242 is obtained through continuous query optimization and/or can be further refined using continuous query optimization. Optimization can be continuously performed (repeated) as further described below. A proportional relationship exists between the time taken to plan a query and the optimality of the query so produced, in that exploring more potential plans will never result in selecting a less optimal plan.

The following figure shows an example process for creating a query plan and a query object.

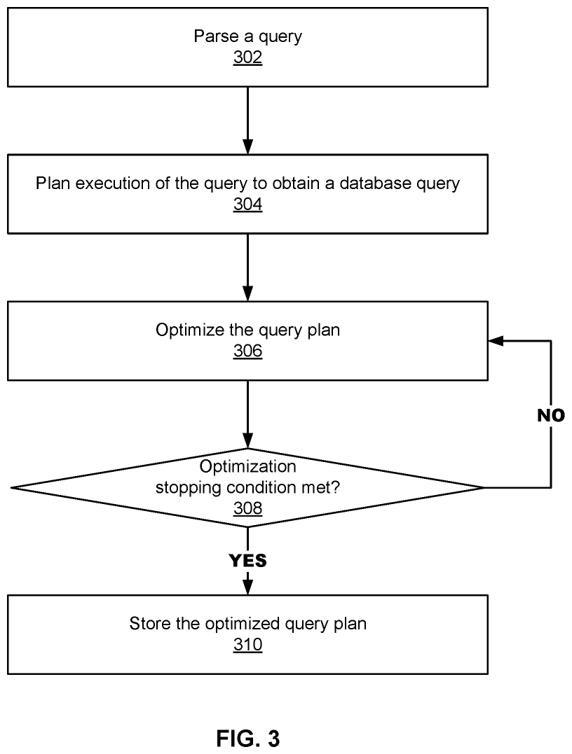

FIG. 3 is a flow diagram illustrating an embodiment of a process for continuous query optimization. This process is an example of how persistently-stored query response information and/or a query object is generated. The persistently-stored query response information or a query object can be used for query handling as described in FIG. 1. This process may be implemented on or by a processor such as data access node of FIG. 4.

In various embodiments, this process is performed when a query is not similar to a previously-received query. Referring to FIG. 1, if a received query is not associated with a query object at 102, then this process is performed to generate a query plan for the query. The query plan may be used by subsequently received similar queries.

The process begins by parsing a query (302). The process parses the query to determine keywords, commands, and instructions for accessing data in a database. In various embodiments, the process builds an abstract syntax tree by parsing the query.

The process plans execution of the query to obtain a database query (304). Planning execution of the query is also referred to as a query plan. Continuing with the example of the abstract syntax tree, the process plans execution of the abstract syntax tree representing the query of 302 to obtain a database query.

In various embodiments, the process optionally also executes the plan. A query may be parameterized, meaning that some syntactic and/or semantic porting of the query may be subject to assignment or substitution when the query is executed as opposed to when the query is planned compiled. Planning a query includes using heuristics to decide which plan is best (e.g., using previous results, based on how much computational resources are available), while executing a query plan is resolving (carrying out) the plan. The disclosed techniques do not require a query plan to resolved, meaning that persistently-store query response information can be associated with a parsed and (as yet) un-resolved query plan.

The process optimizes the query plan (306). The query plan is optimized based on the database query in various embodiments. In various embodiments, continuous optimization as disclosed herein includes the practice of extending the time-box around query planning efforts to be as long as policy dictates, including but not limited to periods well beyond the mandated per-query-execution-request time-box. The optimization can be performed according to various parameters such as time (time-box), space, compute, cost, etc. as defined by a policy. The optimization may continue beyond the time in which a query for which the plan was generated has been responded to. Successive further optimized versions of the plan may be stored, e.g., plan 242 of FIG. 2, as ongoing optimization continues.

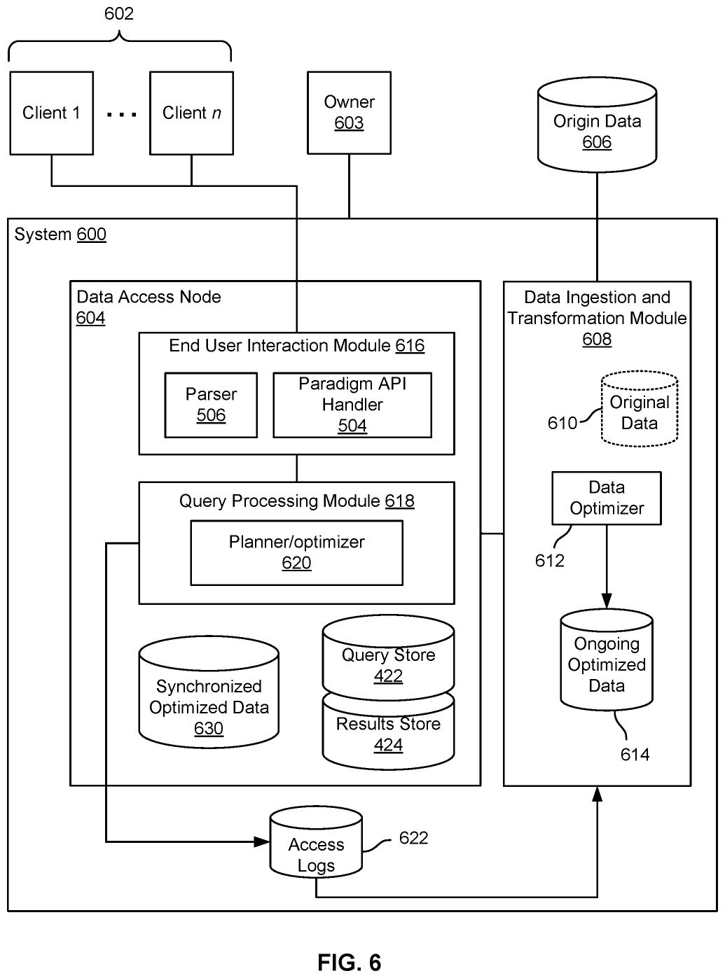

In various embodiments, continuous optimization efforts as disclosed herein execute concurrently with other query planning and execution activities. By doing so, large periods of time outside the normal planning periods become available to extend the planning process. Optimization is no longer constrained by time (time-box) or space available online because at least part of the optimization may be performed offline. In various embodiments, optimization includes determining or suggesting new/different indexes. This can be helpful for determining query similarity where multiple indexes are used by suggesting a different index to use from among several index options. In various embodiments, optimization includes suggesting data transformations. For example, data can be continuously monitored to note changes to data structures such as the dropping of column or other change to organization of data. Data optimization is further described below with respect to data optimizer 612 of FIG. 6. Similarly queries can be continuously monitored to note changes in queries (e.g., new indexes, store the data in a replica of a system of record differently, performing JOINs early) as further described below. The benefits of optimization include, in various embodiments, one or more of: longitudinal optimization, lateral optimization, or reflexive optimizations.

Longitudinal optimization refers to evaluating more potential query plans for an individual query. Lateral optimization refers to evaluating other queries and their plans to determine and exploit useful commonalities or differences. Reflexive optimization refers to (re)organizing individual queries independently from longitudinal and/or lateral optimizations.

As an example of lateral optimization, consider two queries:
SELECT name, sku FROM products WHERE price >50; (Q1)
SELECT name, free_shipping FROM products WHERE price >50; (Q2)

These distinct queries share the same WHERE clause: price >50. As such, an index can be created on products where price >50. The index will, at a minimum, identify the rows for which price >50, and the count of the number of those rows. Basing index creation on common WHERE clause comparisons is one advantage of lateral processing. Such indices reduce the time to process queries, the memory required to process queries, or both.

Another advantage is the concurrent projection of query results. In the queries above, the fields name, sku, and free_shipping are used to populate the result set. If both queries are executed concurrently, the execution of their projection can be combined. That is, if query 1 (Q1) and query 2 (Q2) above are executed, given they will traverse exactly the same rows from the database, rather than do one loop through Q1 to get name and sku, and then another loop through Q2 to get name and free_shipping, the result set for each query is created while processing the same row. Thus, the Nth row would be read once, and a formatted result for Q1 and for Q2 would be created at the same time.

In various embodiments, continuous optimization as disclosed herein helps to determine which WHERE clause results to retain, which query results to retain (WHERE clause and formatted results), and/or which queries are the most likely ones to benefit from the caching of other queries. Because queries have identity (as query objects), the activity surrounding them is easily recorded, including time stamps. In various embodiments, the system uses, but is not limited to, the following metrics as guides to query optimization:
Number of retained where-clause items
A quantitative metric for the amount of sharing (indices, select fields, foreign keys, etc.) between all queries
Min, max, mean, standard deviation, and conditional probability using the time of execution of those queries
Analysis of the distribution of data in columns
Analysis of the predictive value of data between columns
Knowledge of which indices, views, and queries are to be updated and/or recomputed when database data change
Knowledge of which indices, views, and queries are to be updated and/or recomputed when database metadata change

As an example of reflexive optimization consider an optimization (expressed using functional notation) as Opt1(Opt2(Query1)). This optimization might be further simplified as Opt3(Query1) or Opt2(Opt1(Query1)). The simplifications might be more efficient than Opt1(Opt2(Query1)) are therefore optimizations. In various embodiments, these optimizations relate only to the query itself, without reference to longitudinal nor lateral concerns. Thus, they are considered reflexive. Reflexive optimization permits the optimization of previously applied optimizations for a query.

Different policies can be applied at an optimization phase vs. a query execution phase. For example, an example of optimizing to reduce compute cost (e.g., power or electricity usage) during an optimization phase is to use serial processing when power is more expensive (typically during the daytime) and switch to parallel processing when power is less expensive (typically at night). A different policy can be applied when executing the query itself.

As an example of longitudinal optimization, consider a query:
SELECT*FROM products LIMIT 100; (Q3)

Query Q3 gives the first 100 rows. Suppose later another query is received for rows 100 to 200, and a little while later another query is received for rows 200 to 300. It can be anticipated that later similar queries will be received, so it would be beneficial to store additional rows up to a threshold limit (which can be selected based on space for example). If the next 600 rows are stored, then the next query for rows 300 to 400 can be responded to more quickly because it is already available. One use case for this situation is when a client is scrolling through a products page for example. The hint that additional rows or other parts of a table is likely to be requested in later queries can be stored as a characteristic of the table so that data anticipated to be needed next is fetched while currently serving up a retained portion.

Another example of anticipating future queries is to pre-join data in a single products table by structuring the data to have columns that can have arrays (or sub-table). For example, data can be (re)organized into a compound object and/or other data structure (also called an “index”) or format optimized for the types of queries expected to be executed against the data. Examples of compound data structures include arrays and/or other data structures capable of storing multiple values and/or a mix of different types of value. In some embodiments, data may be stored in a row or other structure that includes fields (e.g., columns) in which multiple values are stored, e.g., in an array or table, rather than storing just one value. In some embodiments, upon creating such a new and/or re-formed data structure, a query object and/or associated plan may be updated to use the new and/or re-formed data structure. Upon receiving a subsequent instance of a query associated with the query object, the plan incorporating use of the new and/or re-formed data structure may be used.

Suppose a new category of products is introduced. The way the data is stored can be optimized by storing the category as an array into the single products table. This data can be continuously optimized by pre-computing a JOIN if statistics/distributions of queries seen indicate that this would be favorable according to an optimization policy or parameters. If it is favorable (e.g., the amount of data returned is worth the compute cost), then the transformation request is pushed to a data transformation engine, e.g., 612 of FIG. 6.

The process determines whether an optimization stopping condition is met (308). If the stopping condition is not met, the process returns to 306 to continue optimizing the query plan. For example, the process may determine if one or more optimization parameters are met. If the optimization parameter(s) are not met, then the stopping condition is not met. Otherwise if the stopping condition is met, the process proceeds to store the optimized query plan (310).

The stored optimized query plan can be used for later-received queries that are deemed to be similar to the stored optimized query plan. Using the stored optimized query plan saves time compared to generating a query plan based on the subsequently received query without the benefit of having the stored optimized query plan as a starting point. A singular query (e.g., various versions of essentially the same query) may be executed repeatedly in any of several contexts, including but not limited to the same transaction, the same session, and the same database, with any of the aforementioned being executed by the same user, different users in the same organizational context, or different organizations.

The example above describes optimization (e.g., steps 306-310) as being triggered by query planning and/or execution. However, optimization can be triggered by other events. In one aspect, given the longevity of queries beyond a single execution, as disclosed herein, events other than the planning or execution of a query may cause query optimization to be initiated. For example, a proposed or actual database change, including but not limited to a schema change, can be considered such an event. Proposed changes will trigger re-planning of all or a subset of queries related to the current version of the database, with the plans generated by re-planning being associated with the proposed schema. Since optimizations as disclosed herein may commence independently from query execution requests, the execution duration or a query may or may not be significantly shorter than previous executions.

In various embodiments, optimization can be externalized (performed in a separate instance of the program or performed offline) to avoid competing with other queries for CPU time, memory, and other resources as may be required.

The disclosed continuous query optimization techniques can be implemented by a variety of systems. The following figure shows an example of a system configured to perform continuous query optimization.

FIG. 4 is a block diagram illustrating an embodiment of a system for continuous query optimization. System 400 is configured to perform the processes described herein such as the process of FIGS. 1 and 3. The system includes paradigm API handler 404, parser 406, planner 408, query executor 410, query object creator 412, and one or more query databases 422, and 424. System 400 is communicatively coupled to requestor 402. Each of the components are shown as separate modules for purposes of explanation. One or more of the components may be included in or its functionality implemented by another one of the components. For example, query object creator 412 can be included in planner 408 or its functionality can be implemented by the planner.

Requestor 402 is configured to send requests for data such as queries to data access node 400. Queries may be made in various languages, and for simplicity, the examples here use the example of SQL queries.

Paradigm API handler 404 is a database system/service paradigm and API handler configured to receive queries from a requestor 402. Paradigm API handler 404 recognizes the type of query it receives from requestor 402. For example, if the query is an SQL queries, the paradigm API handler forwards the query to an appropriate parser able to parse SQL queries.

Parser 406 is configured to receive a query and determine its constituent parts including recognizing the syntax and semantics of the query. In various embodiments, parser 406 builds an abstract syntax tree representation of a query, which can be used to determine similarities between queries.

Planner 408 is configured to plan execution of a query including steps to take to find a results set responsive to the query. Planner 408 may access query databases 422 and 424 to find query response information. For example, planner 408 may use query objects to build a results set by determining a query object associated with the query. Planner 408 is configured to store query response information such as query plans in query plan store 422 and to store results sets in query results store 424.

Query executor 410 is configured to execute a query by carrying out a plan made by planner 408 to retrieve the data and build a results set responsive to the query. In various embodiments, it is the query executor that stores query results in results store 424. In various embodiments, planner 408 and/or query executor 410 is configured to perform the horizontal and vertical processing described herein. For example, planner 408 determines whether to perform horizontal or vertical processing (or both) and query executor 410 perform the horizontal and/or vertical processing.

Query object creator 412 is configured to create a query object that corresponds to a query. As described herein, the query object has a unique identifier associating the object with a specific query so that the query may be later referenced. Conventionally, a query is not a first class object. Consequently, queries cannot be passed as a parameter to another function nor can they be manipulated algebraically. By contrast, the disclosed query object can be passed to other functions and manipulated algebraically. The query object is an algebraic object in various embodiments and can be accessed, called, or otherwise manipulated by later queries. For example, the first-class object nature of a query object enables the object (e.g., a VIEW) to be easily copied from one database server to another database server. This is because query response information is retained for the query, so the query object with associated result data, indices, and information beyond just the text of the query can be copied. What is copied to move the query object can be optimized. For example, sometimes it is faster to move an index, while at other times it is faster to re-create it.

The following figure describes the operation of this system.

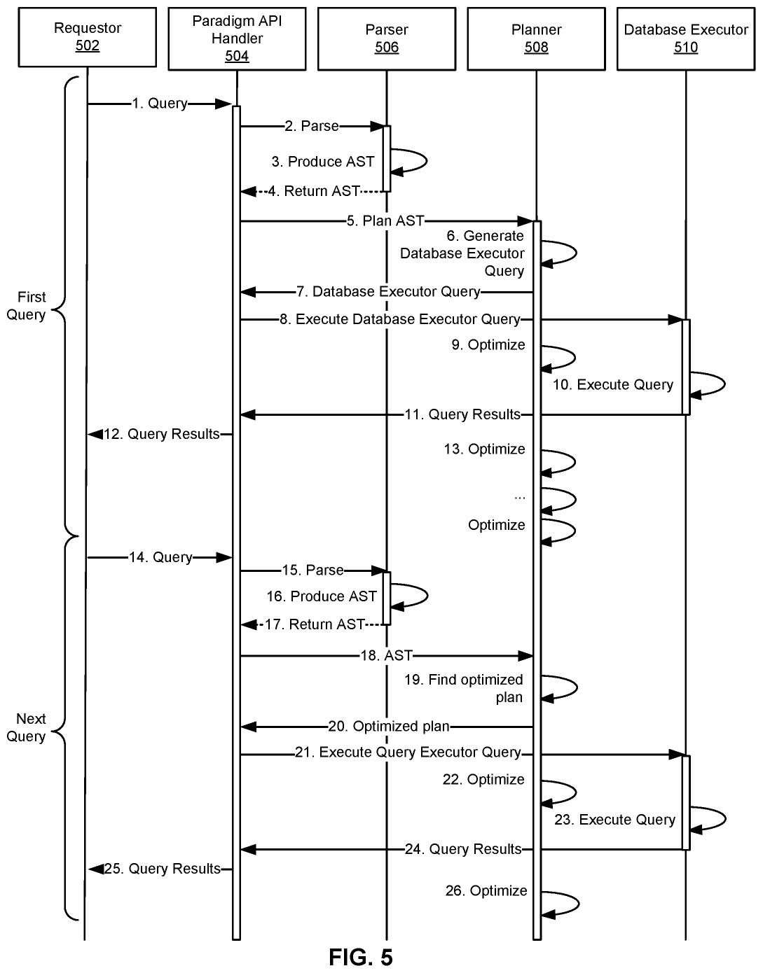

FIG. 5 is a flow diagram illustrating an embodiment of a process for continuous query optimization corresponding to the system shown in FIG. 4. The diagram also shows the various components of FIG. 4 performing the corresponding step in the process. The process shows how two queries (a first query and a next query) are handled. The steps can be repeated for additional queries.

In response to receiving a first query (numbered paragraphs below correspond to numbered arrows in FIG. 5):
1. Requestor 502 presents a query to paradigm API handler 504.
2. Paradigm API handler 504 presents the query to parser 506, which parses the query.
3. Parser 506 produces an abstract syntax tree (AST), and
4. Returns the AST to paradigm API handler 504.
5. Paradigm API handler 504 presents the AST to planner 508.
6. Planner 508 generates a query for execution by query executor 510, and
7. Forwards the query executor query to paradigm API handler 504.
8. Paradigm API handler 504 sends the query executor query to query executor 510 for execution.
9. Planner 508 remains active and optimizes the query plan (this can happen while other steps such as 7 and 8 are being performed).
10. Query executor 510 executes the query, and
11. Sends the query and results to paradigm API handler 504.
12. Paradigm API handler 504 forwards the query and results to requestor 502.
13. Planner 508 further optimizes the query and one or more other queries continuously to produce a highly optimized plan for each of a plurality of queries. The highly optimized plan is referred to as such because it can be the most highly optimized plan possible or optimization can be performed until some stop condition. Optimizations can be performed offline (after query execution is complete). The further optimizations may further optimize the query plan

A next (subsequent) query, can be processed using a previously-devised query plan as follows:
14. Requestor 502 (or another requestor, in some embodiments) presents another query to paradigm API handler 504
15. Parser 506 parses the query,
16. Produces an AST, and
17. Returns the AST to paradigm API handler 504.
18. Paradigm API handler 504 presents the AST to planner 508.
19. Planner 508 finds query response information (e.g., a query and associated optimized plan). In some embodiments, all or part of the AST is processed to identify the query that is currently being processed as being associated with a previously-received query for which an optimized plan is in the retained set of optimized plans. An example of determining association is 102 of FIG. 1 and FIG. 7.
20. Planner 508 returns an optimized query plan, e.g., in the form of a highly optimized query executable by the query executor.
21. Paradigm API Handler 504 presents the plan to query executor 510.
22. Planner 508 optionally concurrently further optimizes queries, while
23. Query executor 510 executes the plan, and
24. Presents the query results to paradigm API handler 504.
25. Paradigm API handler 504 returns results to requestor 502.
26. In some embodiments, planner 508 continues to optimize queries, and so on even after query execution has terminated. The query object is persistent, which allows ongoing optimization (not just optimizing the most recent query).

The system for continuous query optimization shown in FIG. 4 may be included in other systems such as systems for optimized data access. The following figure shows one such example.

FIG. 6 is block diagram illustrating an embodiment of a system for optimized data access. System 600 includes data access node 604 and data ingestion and transformation module 608. Data access node 604 is configured to communicate with clients 602 and to optimize query processing for example by performing the disclosed techniques. Data ingestion and transformation module 608 is configured to communicate with origin database 606 and optimize data. Data ingestion and transformation module 608 and data access node 604 are communicatively coupled, and cooperate to improve clients' user experience by making data more readily accessible among other performance improvements.

For example, data access node 604 polls data ingestion and transformation module 608 for new data, which may be different from a previous poll. The new data is stored in ongoing optimized data store 614. Synchronized optimized data store 630 stores the new data. This enables data access node 604 and data ingestion and transformation module 608 to share information while working independently to perform optimizations, the results of which may be combined in various embodiments.

Data access node 604 and data ingestion module 608 may cooperate as follows. Suppose some data from different tables in origin database 606 are combined into a table in ongoing optimized data store 614 or vice versa (the table is in synchronized optimized data 630). A specific index is selected to be used when searching based on information in synchronized optimized data store 630 and query trends identified by data access node 604. Data ingestion and transformation module 608 generates statistics about the data that are useful to data access node 604 or vice versa. Data ingestion and transformation module 608 helps to perform part of a useful query optimization such as an expensive SQL JOIN. Then the data access node 604 creates indexes on the resulting JOIN table.

Data ingestion and transformation module 608 includes data optimizer 612, ongoing optimized data store 614, and optionally a copy of original data 610. Data ingestion and transformation module 608 is configured to transform data received from origin database 606. In various embodiments, the data ingestion and transformation module performs the transformation according to a set of transformations determined by data optimizer 612.

Data optimizer 612 may include and/or be implemented by an optimization module, layer, and/or process/function completed by cooperation between data access node 604 and data ingestion and transformation module 608. In various embodiments, data optimizer 612 comprises a machine learning layer configured to determine an optimal set of data structures and indexes to store and provide access to data received from origin database 606.

Initially, in some embodiments, data may be stored only in its original form (e.g., in store 610). Over time, data optimizer 612 determines optimal data transformations, such as storing data from two or more relational tables in a single compound data structure, and/or indexing data differently than it may be indexed at origin database 606. Referring further to FIG. 6, transformed data from origin database 606 is stored in ongoing optimized data store 614. Data optimization may be an ongoing or repeated process that updates the optimized data stored in store 614.

Data access node 604 includes end user interaction module 616, query processing module 618, synchronized optimized data store 630, and one or more query-related storages (here query store 422 and results store 424). Client 102 is an example of requestor 502. Requests (e.g., database queries, application-level requests that require queries to be performed, etc.) from client systems 602 are received and processed by end user interaction module 616. In some embodiments, end user interaction module 616 may include application code, user interface code, etc. In some embodiments, end user interaction module 616 may be configured to receive and respond to SQL and/or other queries from clients 602 and/or implied by and/or otherwise required to be performed to respond to requests received from clients 602. End user interaction module 616 includes parser 506 and paradigm API handler 504 for handling queries.

Queries required to respond to requests from client systems 602 are processed by query processing module 618, which includes a dynamic query planner/optimizer 620 (sometimes simply called a query optimizer). Query planner/optimizer 620 is an example of planner 508. Query optimizer 620 may include and/or be implemented by an optimization module, process, and/or layer. In various embodiments, query optimizer 620 determines an optimized manner in which to perform a given query including by performing the techniques disclosed herein such as the process of FIG. 1 or FIG. 3. Query optimizer 620 may be configured to apply conventional query optimization techniques in light of what is known about how the data has been stored and indexed in optimized data 614.

The results or other information associated with query processing module 618 may be stored in one or more stores, here query store 422 and results store 424. Stores 422 and 424 correspond to their counterparts in FIG. 4. Query plans, objects, and results may be stored in the same store or may be separated as shown here 4.

In the example shown, data optimizer 612 included in data ingestion and transformation module 608 performs optimization processing to determine the optimal data structure(s) and/or format in which to store and/or index data ingested by data ingestion and transformation module 608. In various embodiments, the optimization processing is performed offline in batch operations, e.g., using the original data 610. In other embodiments, a remote optimization service may perform optimization processing.

In various embodiments, access logs 622 generated by query processing module 618 and/or received from other, remote data access nodes, are used by optimizer 612 to determine and/or update optimizations to transform and/or index data received from origin database 606. Over time, data in origin database 606 may change, as may the subset of data ingested and stored in local data store 610, queries received from clients 602, priorities of the data owner 603, etc. Data received from origin database 606 is stored in its original, as-received format in original data store 610. In various embodiments, data optimizer 612 and/or another optimization module, system, or service uses original data 610 and data access patterns and/or statistics (e.g., from logs 622) to determine an updated optimal set and type of data structures and/or indexes to be used to store and provide access to data received from origin database 606. In some embodiments, the data optimizer 612 performs optimization processing (e.g., using machine learning, artificial intelligence, and/or other techniques), periodically (e.g., nightly), continuously, or in response to a trigger, until currently optimized to current conditions, etc., in an ongoing effort to improve data access.

While in various embodiments techniques disclosed herein may be implemented on and/or with respect to a system such as system 600, in various other embodiments techniques disclosed herein may be implemented on one or more systems different in one or more respects from system 600.

The following figure formalizes the description above regarding determining similarity between queries, e.g., a query is associated with a query object.

FIG. 7 is a flow diagram illustrating an embodiment of a process for determining that a query is associated with a query object. The process can be performed as part of another process such as part of 102 of FIG. 1.

The process transforms a query into a canonical form representation (702). For example, a query may be parsed and an abstract syntax tree or other hierarchical representation formed.

The process derives a string representative of a portion of the canonical form representation (704). The portion for which the string representative is derived is a semantically relevant portion. There may be one or more portions of a query that is processed and one or more string representative derived for those portion(s).

The process associates the string representative with the query (706). The string representative may be associated with the query, a query object, and/or the (continuously) optimized plan for the query. The string representative may be stored or a hash or other signature thereof may be stored. For example, a predicate is semantically relevant so this subpart of the query gets stored (e.g., hashed).

The process transforms a next query into a canonical form representation (708) and derives a string representative of a portion of the canonical form representation of the next query (710). In other words, a subsequently-received query may be processed at least in part by similarly (to 702 and 704) parsing/transforming the query to derive the corresponding string or other part.

The process determines whether the string representatives of the query and the next query correspond with each other (712). In various embodiments, the string representatives correspond to each other if they are equivalent (syntactically different but semantically the same), or one is subsumed within corresponding information associated with the query object.

If the string representatives correspond with each other then, the process determines that the next query is associated with a query object corresponding to the query (714). The derived information used to determine if an optimized plan for the query is stored. If so, the optimized plan is used to perform the query. Otherwise the process terminates or determines that the next query is not associated with a query object corresponding to the query.

The disclosed continuous query optimization techniques allow highly optimized plans (compared with generating query plans without performing continuous or nearly continuous query optimization as disclosed herein) to be generated. Query response times may be improved by processing a subsequently-received instance of the same or a semantically equivalent query using the highly optimized plan. Query plans may change depending upon the arguments presented to the query. Changing a query plan is expensive compared to using an existing plan. Thus, response times can be improved by using existing plans as much as possible. Conventional methods use existing plans only when queries are considered to be identical, which is not as efficient as the disclosed techniques that recognize similar queries that can benefit from existing plans.

In various embodiments, objective identity for queries dramatically improves the speed with which queries used in different contexts can be assumed to be the same query, as the character representation of the query need not be used, only the identity. In various embodiments, objective identity provides a natural, unique reference to which plans and other related information can be associated. In various embodiments, meta-operations are expressed using the same semantics and syntax in which the queries are expressed. This reduces and may eliminate the need to maintain separate optimization processors and/or languages for expressing and/or executing meta-operations, thereby reducing complexity and memory footprint, simplifying tests and testing methodologies.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory configured to store data that associates persistently-stored query response information with a query object; and
a processor coupled to the memory and configured to:
determine that a query is associated with the query object; and
use the persistently-stored query response information to generate a response to the query.

2. The system of claim 1, wherein the determination that the query is associated with the query object based at least in part on a semantic comparison of the query to the query object.

3. The system of claim 2, wherein the semantic comparison includes determining that at least one portion of the query is at least one of: the same as, equivalent to, or subsumed within corresponding information associated with the query object.

4. The system of claim 3, wherein the at least one portion of the query includes a predicate.

5. The system of claim 1, wherein the determination that the query is associated with the query object is based at least in part on a query object ID being included in the query object.

6. The system of claim 5, wherein the query explicitly invokes the query object.

7. The system of claim 5, wherein the processor is further configured to perform an operation at least one of: on or based on, the query object.

8. The system of claim 7, wherein the operation includes an algebraic operation.

9. The system of claim 1, wherein the determination that the query is associated with the query object includes selecting a query object that best meets an objective from among a plurality of query objects.

10. The system of claim 1, wherein the persistently-stored query response information includes a database query.

11. The system of claim 1, wherein the persistently-stored query response information is generated in response to a previously-received query.

12. The system of claim 11, wherein the persistently-stored query response information includes an optimized query plan generated in response to the previously-received query.

13. The system of claim 12, wherein the optimized query plan is generated by at least one of: longitudinal optimization, lateral optimization, or reflexive optimization.

14. The system of claim 11 wherein the memory is configured to store results associated with the previously-received query.

15. The system of claim 1, wherein the processor is further configured to concurrently project query results for a plurality of queries.

16. The system of claim 1, wherein generating the response to the query is performed without recompiling the query.

17. The system of claim 16, wherein the query has been previously parsed, planned, and computed.

18. The system of claim 1, wherein:
determining that the query is associated with the query object includes determining that the query is associated with a plurality of query objects; and
generating the response to the query includes combining persistently-stored query response information associated with the plurality of query objects.

19. The system of claim 1, wherein generating the response to the query includes populating, using one or more parameters of the query, a query plan associated with the query object for execution.

20. The system of claim 1, wherein the persistently-stored query response information persists across database statement invocations or executions.

21. The system of claim 1, wherein the persistently-stored query response information includes at least one of: information associated with the query or a previously-generated response.

22. The system of claim 1, wherein the persistently-stored query response information includes information associated with a parsed and unresolved query plan.

23. A method comprising:
determining that a query is associated with the query object;
obtaining persistently-stored query response information associated with the query object; and
using the persistently-stored query response information to generate a response to the query.

24. A computer program product embodied in a non-transitory computer readable medium and comprising computer instructions for:
determining that a query is associated with the query object;
obtaining persistently-stored query response information associated with the query object; and
using the persistently-stored query response information to generate a response to the query.
